(19) United States
(12) Patent Application Publication
(10) Pub. No.: US 2005/0163564 A1
(43) Pub. Date: Jul. 28, 2005

(54) Construction system with interlocking connectors

(76) Inventor: Elden C. Tuell, Foothill Ranch, CA (US)

Correspondence Address: STOUT, UXA, BUYAN & MULLINS LLP, 4 VENTURE, SUITE 300, IRVINE, CA, 92618, US

(21) Appl. No.: 11/011,361

(22) Filed: Dec. 13, 2004

Related U.S. Application Data
(60) Provisional application No. 60/539,233, filed on Jan. 26, 2004.

(51) Int. Cl. H01R 33/00

(52) U.S. Cl. 403/403

(57) ABSTRACT

A construction system includes a number of structural elements and a number of connector members for joining the structural elements to one another at virtually any angle. Some of the connector members are configured to connect two or more structural elements at fixed angles to one another, while other connector members allow a structural element to be joined to at least one other structural element at a variable angle.

This application claims the benefit of provisional application Ser. No. 60/539,233, filed Jan. 26, 2004. The disclosure of this provisional application is incorporated in its entirety herein by reference.

### BACKGROUND OF THE INVENTION

The present invention relates to a system for constructing frames and other structures. More particularly, the invention relates to a construction system including a plurality of structural elements and a plurality of connector members for joining the structural elements. At least some of the connector members are structured to interlock with one another at a variable angle.

Frames for buildings and other load-supporting or load-resisting structures can be made of a wide variety of materials including wood, metal, plastics, and numerous composites. Typically, these frames are made from structural elements, for example, elements having structural shapes, such as I-beams, rails, tubes, rods, chords, webs and the like, which are coupled to one another with connector members, such as brackets or clamps.

Various connector members are available for joining solid structural elements, such as beams, made from conventional materials such as wood and metal. However, fewer connector members are available for use with tubular structural elements having polygonal, for instance square, cross-sections, and still fewer, if any, are available for use with structural elements made from relatively new materials, particularly reinforced polymeric materials such as fiberglass. In addition, most available connector members are configured to couple the support elements in predetermined angular relationships to one another, for instance in “T” or elbow configurations, with no capacity for varying the angles.

Accordingly, a need exists for construction systems having connectors that can be adapted for use with both hollow and solid structural elements of various materials and cross-sectional shapes, and that can join the support elements at variable angular relationships to one another.

### SUMMARY OF THE INVENTION

A connector system according to a first broad aspect of the invention comprises a first connector element for mounting on an end of a first structural element, first fastening means for securing the first connector member to the first structural element, and a second connector member for joining another structural element at a variable angle to the first structural element. Preferably, the first connector member comprises a connector body having first and second ends, and an intermediate portion configured to be fastened to the second connector member.

In one embodiment of the invention, effective to join at least three structural elements to form a useful structure, both ends of the connector body are open, allowing the first structural element to be inserted into the first end, and a second structural element to be inserted into the second end. The first and second open ends may be coaxially aligned, thus joining the first and second structural members to form a straight section. Alternatively, the first and second open ends may extend at a fixed angle to one another, joining the first and second structural members to form a corner section. For instance, the first and second openings may extend at right angles to one another, joining the first and second structural members to form an L-shaped, or elbow, section.

In another embodiment of the invention, effective to join two structural elements together, one end of the connector body is closed to define a pocket for capping the end of the first structural element.

Preferably, the second connector member has first and second ends, the first of which is open to receive another structural element. A pair of spaced apart flanges project outwardly from the second end. The flanges define a space for receiving the first connector member at a variable angle. Fastening means are provided for securing the first connector member to the flanges. In some embodiments, the fastening means are in the form of alignable openings in the flanges and in the first connector body, and a fastener, such as a bolt, screw, or the like, extending through the alignable openings. In other embodiments, the fastening means may comprise an adhesive. In still other embodiments, the flanges may include elements of a pivotable interconnection which cooperate with corresponding elements on the first connector member, allowing the structural elements to be pivoted relative to one another. In one advantageous embodiment, particularly useful in situation requiring elements to be joined at non-standard angles, the pivotable interconnection is structured to allow the other structural elements to move at least about 20° to about 30° laterally with respect to the first structural element before reaching its final, static position.

A construction system according to a second broad aspect of the invention comprises at least two elongated structural elements, a first connector member for mounting on an end of a first one of the structural elements, first fastening means for securing the first connector member to the first one of the structural elements, and a second connector member for joining another one of the structural elements to the first connector member. Preferably, the first and second connector members are structured as described above. The structural elements may be formed from a variety of materials, including wood, metal, polymeric materials, and combinations thereof. In one particularly useful embodiment, the structural elements comprise pultruded fiberglass tubes having rectangular, for instance square, cross-sections.

A connector according to a third broad aspect of the invention is useful for coupling a first structural element at a variable angle with respect to a frame including at least one other structural element. The connector comprises a connector body configured to surround the first structural element, a pair of spaced apart flanges extending from the connector body, the flanges defining a space for receiving an end of the other structural element. In one useful embodiment, the flanges are structured to extend along opposite sides of a differently structured connector mounted on the end of the other structural element. In another useful embodiment, the flanges are structured to receive the other structural element in a pivotable interconnection. In either case, the flanges may be substantially triangular in configuration.

Any feature or combination of features described herein is included within the scope of the present invention provided that the features of any such combination are not mutually inconsistent.

Additional aspects and advantages of the present invention are set forth in the following description and claims, particularly when considered in conjunction with the accompanying drawings in which like parts bear like reference numerals.

### BRIEF DESCRIPTION OF THE DRAWINGS

FIG. 1 is a perspective view showing a connector according to the present invention;

FIG. 2 is a perspective view showing a coupling bracket usable with the connector of FIG. 1;

FIG. 3 is a perspective view showing an elbow bracket usable with the connector of FIG. 1;

FIG. 4 is a perspective view showing a T-bracket usable with the connector of FIG. 1;

FIG. 5 is a perspective view showing a pocket bracket usable with the connector of FIG. 1;

FIG. 6 is a square truss configuration incorporating connectors as shown in FIG. 1 and elbow brackets as shown in FIG. 3;

FIG. 7 is a rectangular truss configuration incorporating connectors as shown in FIG. 1 and elbow brackets as shown in FIG. 3; and

FIG. 8 is a triangular truss configuration incorporating connectors as shown in FIG. 1 and pocket brackets as shown in FIG. 5;

FIG. 9A is an end view of an alternate pocket bracket

FIG. 9B is a plan view of the bracket shown in FIG. 9A;

FIG. 9C is a front view of the bracket shown in FIG. 9B;

FIG. 10 is a pivoting connector system according to the present invention;

FIG. 11 is a pivoting connecting system according to an alternate embodiment of the invention;

FIG. 12 shows a set of angle brackets having flanges for receiving a pivot ball;

FIG. 13 is an end view of a connector configured to cooperate with the angle brackets of FIG. 12;

FIG. 14 is a side view of the connector of FIG. 13;

FIG. 15 is a plan view of a connector member for forming a rounded corner between structural elements;

FIG. 16 is a front view of the connector member of FIG. 15;

FIG. 17 is a schematic view of a framework incorporating various connectors of the present invention;

FIG. 18 is an end view of a three-dimensional structure according to the present invention;

FIG. 19 is a plan view of the structure of FIG. 18;

FIG. 20 is a perspective view of a corner truss bracket according to the present invention;

FIG. 21 is a view showing the corner truss bracket of FIG. 20 in combination with the T-bracket of FIG. 4;

FIG. 22 is a plan view of ridge plate for joining two structural elements at a fixed angle relative to a third structural element;

FIG. 23 is an end view (with exaggerated thickness) of the ridge plate of FIG. 22;

FIG. 24 is a fragmentary end view of an A-frame structure incorporating a set of connector members of the types shown in FIGS. 9A and 22;

FIG. 25 is a view of a T-bracket according to an alternate embodiment of the invention.

### DETAILED DESCRIPTION OF THE DRAWINGS

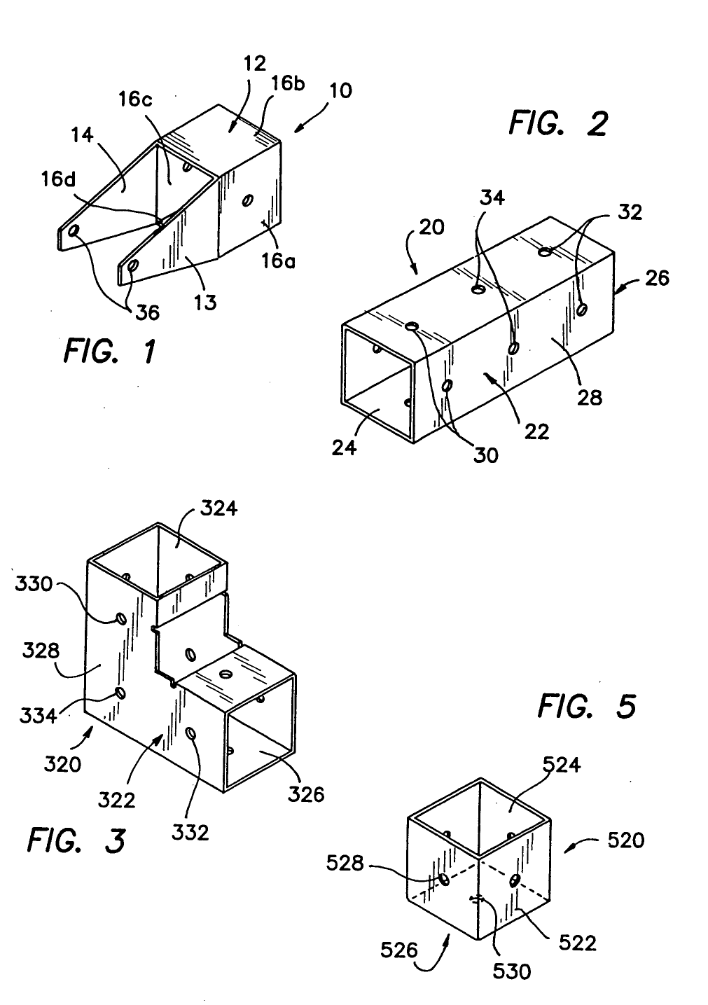

Referring first to FIG. 1, a connector 10 according to the present invention, also called a web point bracket, comprises a connector body 12 configured to extend around an end of a structural element, and a pair of spaced apart flanges 13, 14 extending from the connector body. The flanges 13, 14 define a space allowing the connector body 12 to receive and interlock with another connector having a different structure, such as, for instance, any of the connectors shown in FIGS. 2-5, 9A-C and 15-16.

The connector body 12 is illustrated here as having four square side walls 16a,b,c,d allowing the connector body to be received on the end of a structural element having a substantially square cross-section. However, the invention is not limited to use with structural elements of any particular cross-section; thus, the cross-sectional shape of the connector body 10 may be selected as necessary to match the cross-sectional shape of the structural element on which it is to be mounted. For example, the connector body 12 may have an annular cross-section allowing it to be used with pipes or rods having round cross-sections, or a hollow rectangular cross-section allowing it to be used with beams having polyhedral, such as square or rectangular, cross-sections.

FIG. 2 shows a connector 20, also called a coupling bracket, used to join a pair of structural elements in end-to-end, coaxially aligned relationship to one another. The connector 20 includes a connector body 22 having a first open end 24 for receiving a first structural element, a second open end 26 for receiving a second structural element, and an intermediate portion 28 configured to be received between the flanges 13, 14 of the web point bracket 10 of FIG. 1.

The connector body 22 may comprise at least three sets of apertures, including a first set of apertures 30 near the first end 24, a second set of apertures 32 near the second end 26, and a third set of apertures 34 in the center of the intermediate portion. The first set of apertures 30 is structured to receive a first fastener or set of fasteners such as a bolt, pin, or screw (not shown), for securing the first structural member to the coupling bracket 20. The second set of apertures 32 is structured to receive a second fastener or set of fasteners for securing the second structural member to the coupling bracket 20. The third set of apertures 34 is structured to receive a third fastener or set of fasteners which extend through corresponding apertures 36 in the flanges 13, 14 of the web point bracket 10 to secure the web point bracket 10 at a variable angle with respect to the coupling bracket 20.

In certain cases, for instance when either the connector 20 or a structural member coupled to the connector is formed from a composite or carbon fiber material, the apertures 30, 32 and 34 and corresponding fasteners may be eliminated, and the connector 20 may be secured to the structural members and the web point bracket 10 using an adhesive such as epoxy or resin or the like.

An alternate connector 320, also called an elbow bracket, is illustrated in FIG. 3. The elbow bracket 320, used to couple a pair of structural elements at right angles to one another, comprises a connector body 322 having a first open end 324, a second open end 326, and a generally L-shaped intermediate portion 328 extending between the two ends. As in the previous embodiment, the connector body 322 includes three sets of apertures 330, 332, and 334 for receiving fasteners for securing the connector 320 to the first structural element, the second structural element, and the flanges 13, 14 of the web point bracket, respectively.

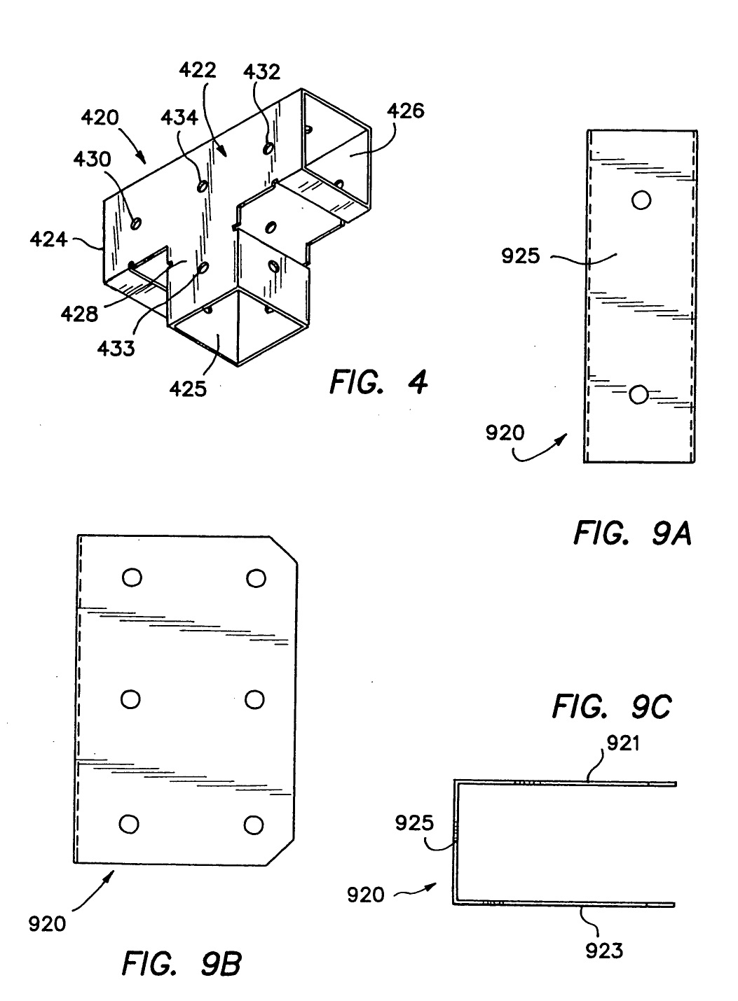

FIG. 4 shows a connector 420, also called a T-bracket, for coupling three structural elements in a “T” configuration. The T bracket comprises a connector body having first and second open ends, 424, 426 coaxially aligned with one another, and a third open end 425 that extends along an axis (not shown) that perpendicularly bisects the common axis of the first and second ends 424, 426. A T-shaped intermediate portion 428 extends between the openings.

Four sets of apertures are provided in the connector body 422, including a first set of apertures 430 near the first open end 424 for receiving a fastener or set of fasteners to secure the first structural element to the connector body 422, a second set of apertures 432 near the second open end 426 for receiving a fastener or set of fasteners to secure the second structural element to the connector body 422, a third set of apertures 433 near the third open end 425 for receiving a fastener or set of fasteners to secure the third structural element to the connector body 422, and a fourth set of apertures 434 for receiving a fastener or set of fasteners which extend through corresponding apertures 36 in the flanges 13, 14 of the web point bracket 10 to secure the web point bracket 10 at a variable angle with respect to the T-bracket 420.

A pocket bracket 520 for coupling a single structural element to the web point bracket 12 is shown in FIG. 5. The pocket bracket 520 comprises a connector body 522 having an open first end 524 for receiving the structural element and a closed second end 526 for forming a cap or pocket over the end of the structural element.

The pocket bracket 520 includes a plurality of apertures for receiving fasteners. In the illustrated embodiment, one aperture 528 is provided in each side wall of the pocket bracket 520. The apertures in one pair of opposed side walls may receive a fastener or set of fasteners for securing the structural element to the pocket bracket, while the apertures in the other pair of opposed side walls may receive a fastener or set of fasteners which extend through corresponding apertures 36 in the flanges 13, 14 of the web point bracket 10 to secure the web point bracket 10 at a variable angle with respect to the T-bracket 420. Still another aperture 530 in the closed second end 526 of the pocket bracket 520 may receive a fastener extending through an aligned aperture or set of apertures of yet another connector member. For example, the aperture 530 may be aligned with fasteners extending through the fourth aperture or set of apertures 434 in the T-bracket 420, thus securing the pocket bracket 520 to the T-bracket 420.

FIGS. 9A-C show an alternate pocket bracket according to the present invention. The function and structure of the pocket bracket 920 is generally similar to the pocket bracket 520 of FIG. 5, except that it includes only two opposed side walls 921, 923, rather than the four side walls shown in FIG. 5. In addition, the side walls 921, 923 are elongated relative to the end wall 925. Each elongated side wall, 921, 923 includes two rows of fastener receiving apertures, in contrast to the single aperture per side shown in FIG. 5.

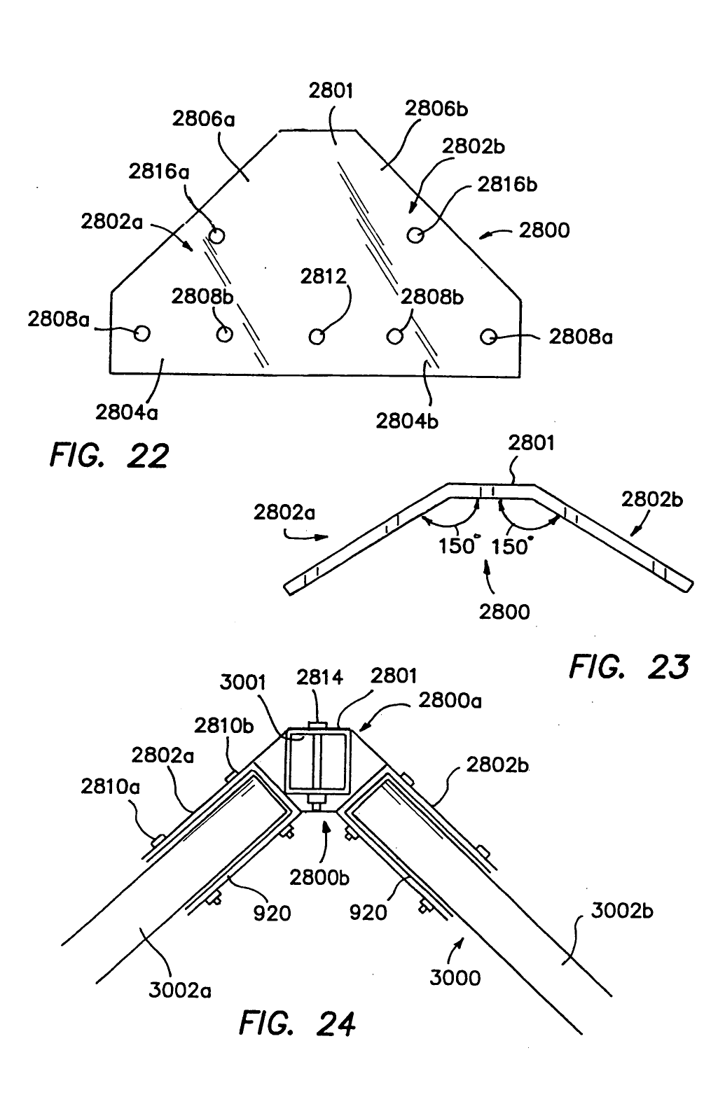

The alternate pocket bracket of FIGS. 9A-9C is particularly useful in combination with ridge plates 2800 of the type shown in FIGS. 22 and 23, for assembling an A-frame truss 3000 as shown in FIG. 24. Specifically, a ridge plate 2800 comprises a central spine portion 2801 and a pair of wing portions 2802a, b, each extending at a fixed angle (150° in this embodiment) with respect to the spine portion 2801. The central spine portion is configured to extend longitudinally along the ridge pole 3001 of the A-frame structure, while a generally rectangular base portion 2804a, b of each wing portion 2802a, is configured to extend longitudinally along a support member 3002a, b that extends at an angle of 120° to the ridge pole 3001. A generally triangular web support portion 2806a, b extends between each base portion 2804a, b and the spine portion 2801. Each base portion 2804a, b includes a pair of apertures 2808a, b that are alignable with corresponding apertures in the pocket bracket 920 mounted on the end of the associated support member 3002a, b and adapted to receive fasteners 2810a, b that secure the ridge plate 2800 to the pocket bracket 920 and the support member 3002. Another aperture 2812 is provided at the base of the spine portion 2801 for receiving another fastener 2814 for securing the spine portion to the ridge pole 3001. Still another aperture 2816a, b is provided in each of the web support portions 2806a, b for receiving a fastener to secure a web or other support element (not shown) at a variable angle to the ridge plate 2800.

As shown in FIG. 24, the ridge plate 2800 of FIGS. 22 and 23 is actually one of a pair of ridge plates 2800a, b, with the ends of the support members 3002a, b and ridge pole 3001 being sandwiched between an upper ridge plate 2800a and lower ridge plate 2800b.

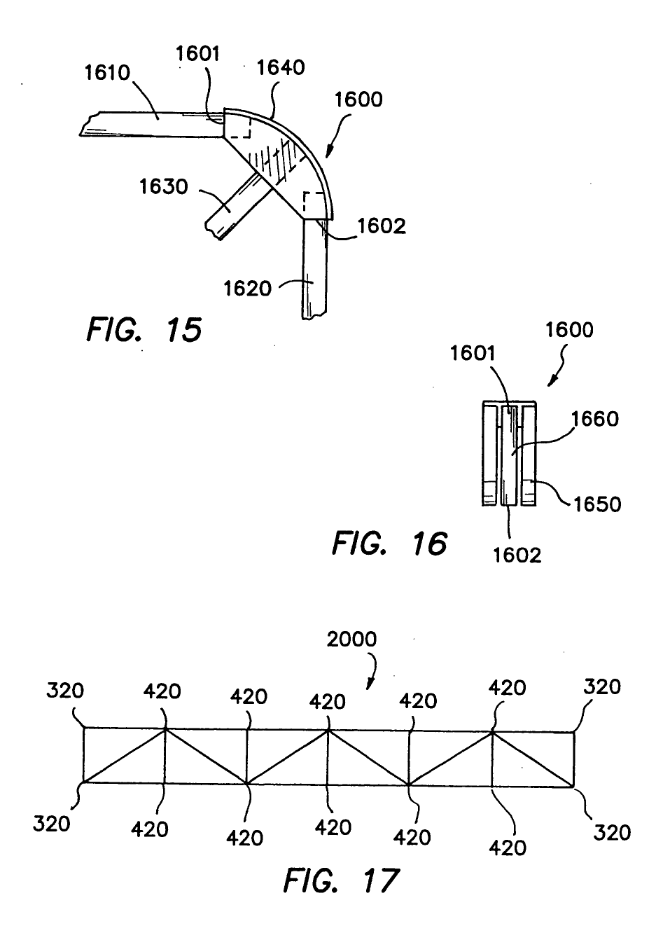

FIGS. 15 and 16 show a connector member 1600 somewhat similar in function to the T-connector of FIG. 4. However, rather than joining two structural elements coaxially to one another, with a third structural element extending perpendicularly to the first two elements, the connector member 1600 is configured to join two structural elements 1610, 1620 at right angles to one another, with a third structural element 1630 joining the first two elements at an acute angle. The outer surface 1640 of the connector member 1600 is curved to form a rounded corner between the structural elements. The inner surface 1650 of the connector member 1600 includes a channel 1660 for receiving an end of the first structural element 1610 at one end 1601 and an end of the second structural element 1620 at the other end 1602. The end of the third structural element 1630 may be positioned anywhere along the channel 1600 depending on the angle needed. For instance, the end of the third structural element 1630 may be positioned halfway between the first structural elements 1610 and 1620 to form a 45° between the third structural element 1630 and the first and second structural elements 1610, 1620, or it may be positioned closer to the first structural element 1610 to form a smaller angle with the first structural element 1610 and a larger angle with the second structural element 1620, and so forth.

Although each of the connector bodies in FIGS. 1-5, 9A-C, 15, 16, 22 and 23 is shown as a unitary structure, in some applications the connectors may be easier to manufacture and manipulate if provided in two-piece sections. For instance, FIG. 25 shows a bracket half 420A configured to cooperate with a mirror-image mating bracket half (not shown) to form a T-bracket similar to that shown in FIG. 4. Although not expressly shown, each of the other connectors described herein may also be provided in two piece form, without departing from the principles of the present invention.

As in the embodiment of FIG. 1, the embodiments of FIGS. 2-5, 9A-C, 15, 16, and 20-25 are not limited to use with structural elements having any particular cross-sectional shape. In other words, the cross-sectional shape of any of the connector bodies 22, 32, 42 and 52 may be selected as necessary to match the cross-sectional shape of the structural element or elements on which it is to be mounted. Similarly, the number and placement of the apertures in each connector body need not be limited to the arrangements shown, but may be varied to suit particular applications.

For the purposes of this application, any combination of connectors allowing a structural element joined at a variable angle with respect to another structural element may be considered a connector system. For instance, a system including the web point bracket 10 of FIG. 1 in combination with any of the brackets or connectors shown in FIGS. 2-5, 9A-C, 15 and 16 is a connector system. At least one connector in combination with at least two structural elements is considered a construction system.

The structural members or elements useful in accordance with the present invention may have any suitable shape or combination of shapes and may be made of any suitable material or combination of materials. For example, and without limitation, the structural members or elements may be shaped or configured as I-beams, W-beams, rails, tubes or tubular, rods, chords, webs and the like. In addition, the structural members or elements may be solid, hollow, porous or the like or combinations thereof.

In a particularly useful embodiment of a construction system according to the present invention, the structural elements are fiberglass tubes having square cross-sections. The tubes are preferably formed by pultrusion—a manufacturing process similar to extrusion, in which the tubes are pulled, rather than pushed, through the extruder. Fiberglass tubes formed in this manner are durable, economical, have excellent strength-to-weight ratios, and are useful in a wide variety of fields including architecture, home improvement, recreation, and automotive accessories.

Structural elements formed of other materials, such as, without limitation, metal, wood, plastics, and composites or combinations thereof, may also be used with the connectors of the present invention, and are included within the scope thereof. In one advantageous embodiment, the structural elements are formed from a material selected from the group consisting of composite materials including at least one polymeric material, reinforced polymeric materials and polymeric materials other than polyvinylchloride (PVC). Particularly useful materials include carbon fiber composites and poly(p-phenylenterephthalamide) fiber, also known as Kevlar®.

The connector members themselves may also be made from a variety of materials including, without limitation, metals, plastics, fiber-reinforced plastics, epoxy and the like and mixtures thereof. In applications requiring high strength, metal, such as stainless steel, connectors, reinforced connectors, such as connectors including carbon fibers, and the like connectors may be preferred. In one advantageous embodiment, the connector members are formed from a material selected from the group consisting of composite materials including at least one polymeric material, reinforced polymeric materials, and polymeric materials other than acrylonitrile-butadiene-styrene (ABS). When the structural elements are made from carbon fibers, connector members made from structural epoxy are particularly useful.

The connector members or connectors may be of any suitable size, that is any size effectively usable in a given application. In one embodiment, the connector members or connectors may have a maximum transverse dimension, that is a maximum straight line dimension from one point on a connector member to another point on the connector member, in a range of about 0.5 inch or less to about 12 inches or more.

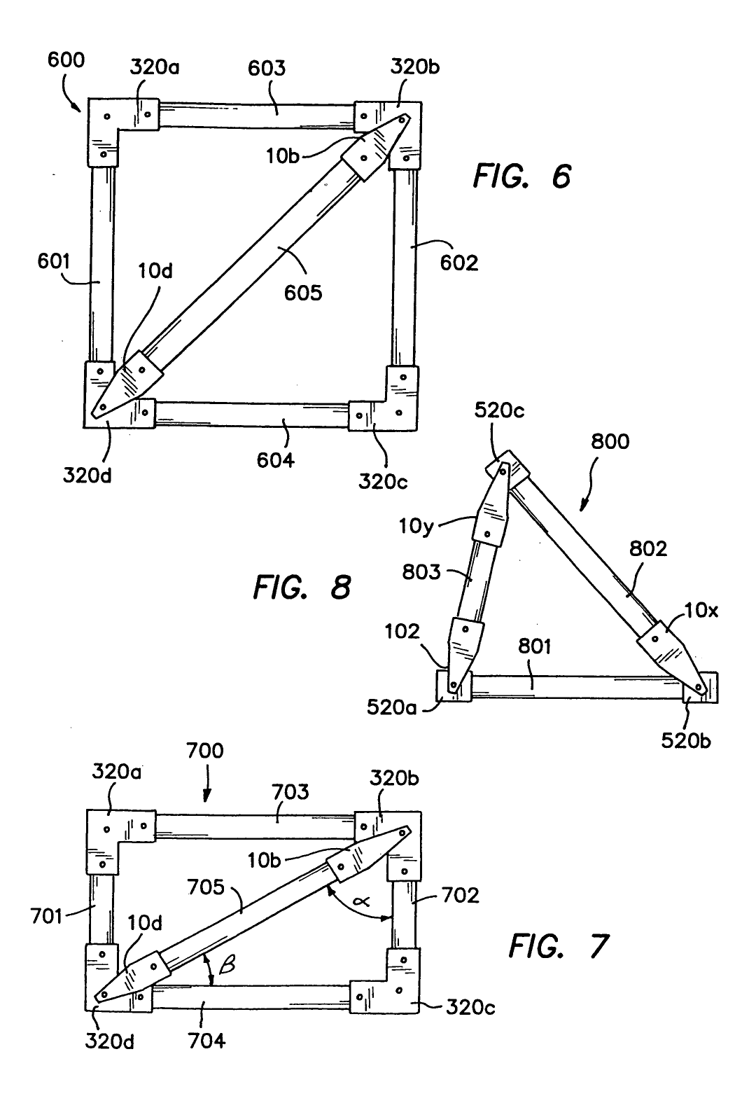

FIGS. 6-8 show various trusses that may be constructed using a construction system according to the present invention.

FIG. 6 shows a square truss 600 comprising a pair of vertical support elements 601, 602 and a pair of horizontal support elements 603, 604 joined at the corners by elbow brackets 320a, b, c, d according to the present invention. A web element 605 extends diagonally between opposed corners of the truss 600, and is joined to the corresponding elbow brackets 320b, d by web point brackets 10b, d mounted on opposite ends of the web 605. The web forms a 45° angle with respect to each of the support elements 601, 602, 603, 604.

FIG. 7 shows a rectangular truss 700 substantially identical in configuration to the square truss 600 of FIG. 6, except that the vertical support elements 701, 702 are shorter than the horizontal support elements 703, 704. Thus, the angle β between the web 705 and either of the vertical support elements 701, 702 is greater than the angle β between the web 705 and the corresponding horizontal support elements 703, 704.

FIG. 8 shows a triangular truss 800 comprising a first support element 801 having a first pocket bracket 520a mounted on one end and a second pocket bracket 520b mounted on its opposite end. A second support element 802 is coupled to the second pocket element 520b by means of a first web point bracket 10x. A third pocket bracket 520c at the other end of the second support element 802 is coupled to a second web point bracket 10y on an end of a third support element 803. A third web point bracket 10z at the other end of the third support element 803 is coupled to the first pocket bracket 520a on the first support element 801.

It should be noted that while the angle between the web point bracket 10 and the other connector bodies 20, 320, 420 and 520 is described herein as “variable”, the angle in the foregoing embodiments is only variable in the sense that it is not predetermined. For instance, the same web point bracket may be secured at 45° with respect to both ends of an elbow bracket 320, as shown in FIG. 6, or it may be secured at different angles, α, β with respect to the different ends, as shown in FIG. 7. However, once the flanges 13, 14 of the web point bracket are fastened to the elbow bracket, the angles α, β are intended to remain fixed. In other words, there is no pivoting movement of any of the structural elements relative to one another.

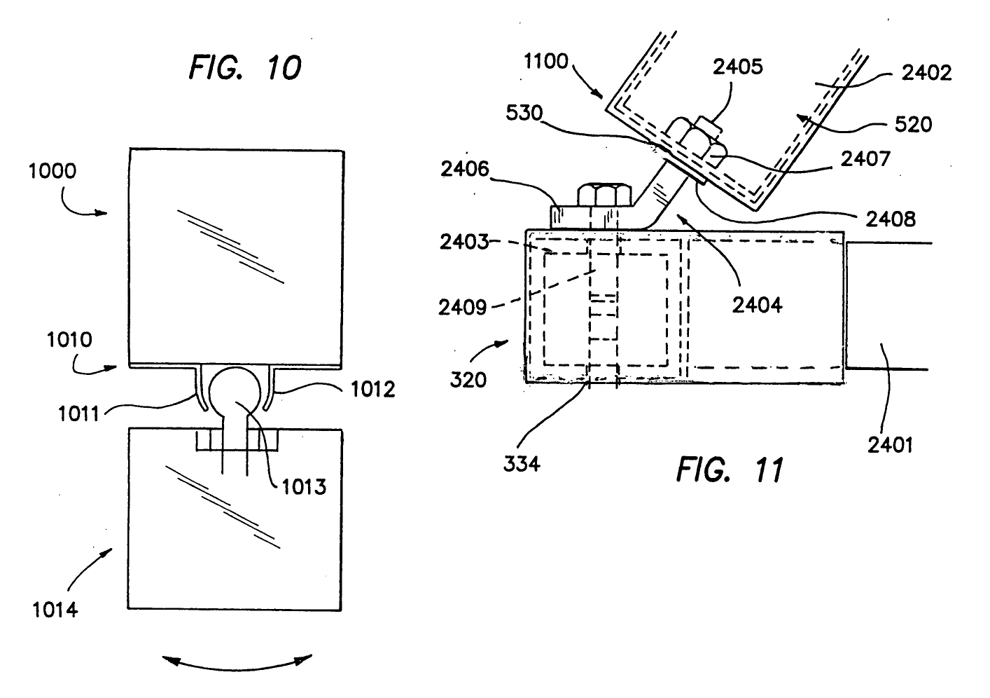

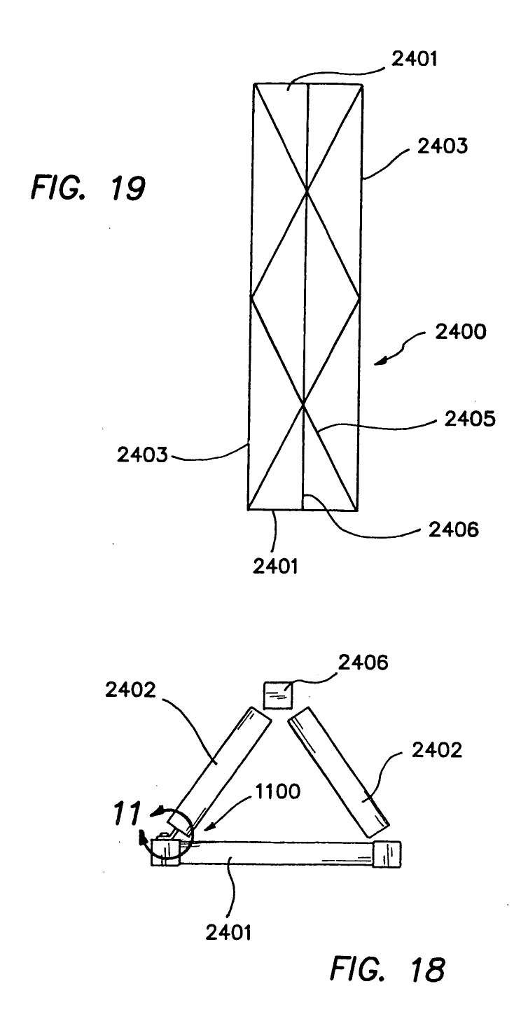

Other embodiments of the invention, shown in FIGS. 10-14 and described below, do allow pivoting movement of one structural element relative to another, as long as the distal ends of the structural elements remain free. However, once structural elements joined by the connectors shown in any of the embodiments of FIGS. 10-14 are incorporated into a triangular structure, as shown for instance in FIGS. 18 and 19, the angular relationship between elements is fixed, due to the inherently stable nature of the triangular configuration.

FIG. 10 shows a pivotable connector system 1000 comprising a first connector member 1010 having spaced apart flanges 1011, 1012 defining a socket for receiving a pivot ball 1013 projecting from a second connector member 1014.

FIG. 11 shows an alternate pivotable connector system 1100 particularly useful in constructing a pyramid-shaped structure 2400 of the type shown in FIGS. 18 and 19. The pyramid structure 2400 comprises a rectangular base section including laterally extending base elements 2401 and longitudinally extending base elements 2403. The base section is connected at each end to a pair of angled vertical structural members 2402 which may be coupled to a ridge pole 2406 by means of ridge plates of the type shown in FIGS. 22 and 23, thus forming the triangular configuration shown in FIG. 18. Web members 2405 extending from the corners and longitudinal centers of the base section to the ridge pole 2406 provide additional support.

The system 1100 comprises an elbow bracket 320 of the type shown in FIG. 3, which joins two base structural members 2401, 2403 at right angles to one another, in combination with a pocket bracket 520 of the type shown in FIG. 5, mounted on an end of an angled vertical structural member 2402. The pocket bracket 520 is joined at a variable angle to the elbow bracket 320 by a specially configured swivel connector 2404 having a male end 2405 and a female end 2406. The male end 2405 is received in an aperture 530 in the closed end of the pocket bracket 520, and retained therein by means of a nut 2407 and washer 2408 or equivalent arrangement. The female end 2406 is configured as a spherical bearing that receives a bolt 2409 or other fastener extending through apertures 334 in the elbow bracket 320, thus allowing the vertical structural member 2402 to be pivoted or swivelled relative the base structural members 2401, 2403.

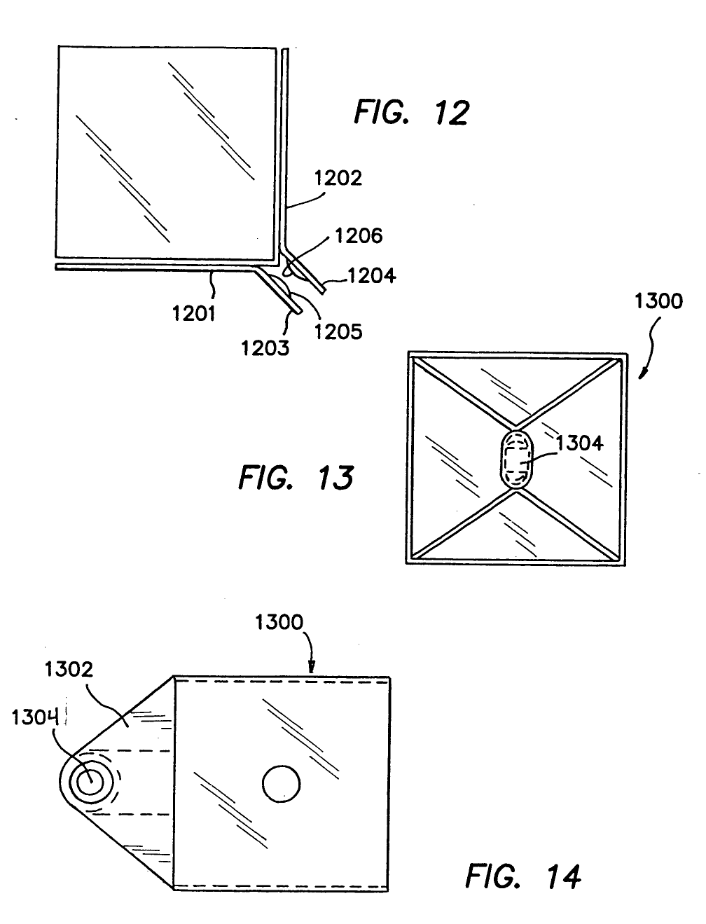

FIG. 12 shows a pair of angle brackets 1201, 1202 that may be mounted on adjacent sides of a corner of a structural member. Each angle bracket includes a flange portion 1203, 1204 having a protrusion 1205, 1206 formed thereon.

FIGS. 13 and 14 show a specially configured pocket bracket 1300 having a flange 1302 projecting from its closed end. A pivot ball or spherical bearing 1304 formed on the flange 1302 is receivable between the protrusions 1205, 1206 on the flanges 1203, 1204 of the angle brackets, thus forming a pivotable interconnection between the pocket bracket 1300 and the angle brackets 1201, 1202. The illustrated connection allows about 20° to about 30° of relative lateral movement, or adjustment, between two structural members before the assembly is fixed in its final state. Thus, the connection is useful in structures requiring non-standard angular configurations.

Other pivoting arrangements such as, for instance, hinge arrangements, can readily be envisioned by the skilled practitioner, and are included within the scope of the present invention.

FIG. 17 is an elongated frame 2000 comprising a plurality of horizontal structural elements, a plurality of vertical structural elements, and a plurality of webs. The structural elements defining the outermost corners of the frame 2000 are coupled to one another using the elbow brackets 320 of FIG. 3. The remaining horizontal and vertical structural elements are coupled to one another using T-the brackets 420 of FIG. 4. Each of the webs is coupled to an elbow bracket 320 or T-bracket 420 using the web point bracket 10 of FIG. 1, although for the sake of simplicity, the web point brackets are not labeled in the drawing.

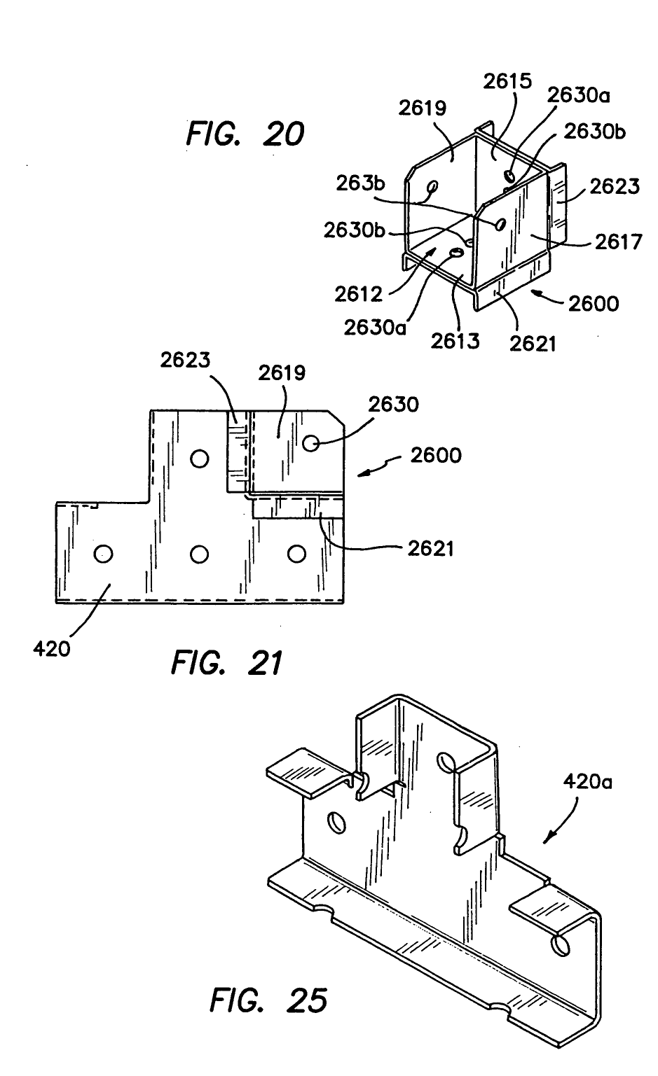

FIG. 20 shows a corner truss bracket 2600 configured to be mounted in the corner formed by an elbow bracket 320 or a T-bracket 420, performing a function similar to that of the web point bracket 10 of FIG. 1. Referring also to FIG. 21, which shows the corner truss bracket 2600 in combination with a T-bracket 420, the corner truss bracket 2600 includes a generally L-shaped connector body 2612 comprising a pair of perpendicularly disposed end walls 2613, 2615. A pair of side walls or flanges 2617, 1619 is secured to the connector body 2611 along opposite edges of the end walls. A first generally U-shaped coupling portion 2621 is secured to the reverse side of one of the end walls 2613, for engaging a horizontally extending portion of a T-bracket 420 or elbow bracket 320, and a second generally U-shaped coupling portion 2623 is secured to the reverse side of the other end wall 2615, for engaging a vertically extending portion of the T-bracket 420 or elbow bracket 320.

Each of the side walls or flanges 2617, 2619 includes an aperture 2636 for receiving a fastener or fasteners, allowing a web or other structural element to be secured at a variable angle with respect to the bracket 2600. Similarly, each of the end walls 2613, 2615 includes apertures for receiving fasteners allowing the bracket to be secured at a fixed angle with respect to the horizontal and vertical portions of the T-bracket 420 or elbow bracket 320. In this embodiment, a pair of apertures 2630a, b is provided in each end wall, rather than the single aperture of the previous embodiments. The double apertures allow two fasteners to secure the connector to two different structures, without interfering without one another. For instance, one aperture 2630a may receive a first fastener for securing the connector bracket to the T-bracket, while the other aperture may receive a second fastener for securing the connector bracket to a structural element within the T-bracket. This double aperture arrangement is not limited to the corner truss bracket of FIG. 26, but may in fact be used with any of the connectors or brackets described above.

Various applications for the construction system disclosed herein will occur to the practitioner skilled in the art. For instance, the system may be used to construct a variety of commercial structures, both permanent and temporary, including industrial shelving, corrosive areas structures, job site structure, cell site structures, remote area medium size buildings, hand railings, mezzanine structures, non-conforming material areas and cages, office and industrial work stations, machine frames and guards, material handling systems, benches and tables, test fixtures, work carts, rack systems, information areas, kiosks, stadium seating and bleachers. The system may also be used in home applications such as garage shelving, playground equipment (i.e. swingsets), outdoor DIY construction, and modern architectural structures. The system may also be used in marine or seaside environments, for instance to construct deck railings, corrosion-resistant decks, manways, and platforms, marina walkways, roofs and slips, and oil platforms. Sports equipment, such as soccer goals or softball backstops, as well as automotive equipment, including pick-up racks, brushguards, RV roof racks, stake beds and sideboards for trucks, and utility bed racks, can also be constructed using the system described herein.

While this invention has been described with respect to various specific examples and embodiments, it is to be understood that the invention is not limited thereto and that it can be variously practiced within the scope of the following claims.

1. A connector system effective to join two or more structural elements to form a useful structure, comprising:
a first connector member configured to be mounted on an end of a first structural element; and
a second connector member configured to be mounted on an end of a second structural element and to join the second structural element at a variable angle to the first structural element.

2. A connector system according to claim 1, wherein the first connector member comprises a connector body having:
first and second ends, the first end defining a first opening for receiving the first structural element; and
an intermediate portion configured to be fastened to the second connector member.

3. A connector system according to claim 2, wherein the second end defines a second opening for receiving a second structural element.

4. A connector system according to claim 3 wherein the first connector body defines a longitudinal axis, and wherein the first and second openings are coaxially aligned.

5. A connector system according to claim 3 wherein the first opening defines a first longitudinal axis, and the second opening defines a second longitudinal axis extending perpendicularly with respect to the first longitudinal axis.

6. A connector system according to claim 2 wherein the second end is closed to define a pocket capping the end of the first structural element.

7. A connector system according to claim 1, wherein the second connector member comprises:
a second connector body having first and second ends, the first end defining an opening configured to receive the second structural element; and
a pair of spaced apart flanges projecting outwardly from the second end, the flanges defining a space for receiving the first connector member.

8. A connector system according to claim 7, further comprising:
a first set of apertures in the first connector body alignable with a second set of apertures in the spaced apart flanges of the second connector body;
at least one fastener engaging the first and second set of apertures to secure the first connector body to the second connector body.

9. A connector system according to claim 7, wherein the flanges are substantially triangular in configuration.

10. A connector system according to claim 1, wherein the first and second connector members include first and second elements of a pivotable interconnection allowing the second structural element to be pivoted relative to the first structural element.

11. A connector system according to claim 10, wherein the pivotable interconnection is configured to allow the second structural element to move at least about 20° to about 30° laterally with respect to the first structural element.

12. A connector for coupling a first structural element at a variable angle with respect to a frame including at least one other structural element, the connector comprising:
a connector body configured to surround the first structural element; and
a pair of spaced apart flanges extending from the connector body, the flanges defining a space for receiving an end of the other structural element.

13. A connector according to claim 12, wherein the frame includes a differently structured connector mounted on the end of the other structural element, and wherein the flanges are configured to extend along opposite sides of the differently structured connector.

14. A connector according to claim 12, further comprising apertures formed in the connector body for receiving fasteners to secure the connector body to the first structural element.

15. A connector according to claim 13, further comprising apertures formed in the flanges for receiving fasteners to secure the connector body to the differently structured connector.

16. A connector according to claim 12, wherein the flanges are substantially triangular in configuration.

17. A connector according to claim 12, wherein the flanges are structured to receive at least a portion of the other structural element in a pivotable interconnection.

18. A connector according to claim 17, wherein the pivotable interconnection is configured to allow the other structural element to move at least about 20° to about 30° laterally with respect to the first structural elements.

19. A construction system for forming a useful structure, comprising:
at least three elongated tubular structural elements formed of polymeric material; and
a connector member having a first end configured to receive a first one of the structural elements, a second end configured to receive a second one of the structural elements so that the second structural element extends at a predetermined angle to the first structural element, and an intermediate portion configured to be coupled to an end of a third one of the structural elements so that the third structural element extends at an angle other than the predetermined angle to the first and second structural elements.

20. A construction system according to claim 19, wherein the connector member includes a curved surface configured to form a rounded corner between the first and second structural elements.

21. A construction system according to claim 19, wherein the predetermined angle is substantially about 90°.
